(19) United States
(12) Patent Application Publication
(10) Pub. No.: US 2022/0318914 A1
(43) Pub. Date: Oct. 6, 2022

(54) METHOD AND SYSTEM FOR GRAPH-BASED ATTRIBUTION ANALYSIS

(71) Applicant: JPMorgan Chase Bank, N.A., New York, NY (US)

(72) Inventors: Xiaotao WU, West Windsor, NJ (US); Shuo CHEN, New York, NY (US); Grant CHANG, Fresh Meadows, NY (US); Xueqing HU, Flushing, NY (US); Rafael FORTE, White Plains, NY (US); Ricardo ARNT, Ho-Ho-Kus, NJ (US); Dmitriy FRENKEL, Brooklyn, NY (US)

(73) Assignee: JPMorgan Chase Bank, N.A., New York, NY (US)

(21) Appl. No.: 17/657,005

(22) Filed: Mar. 29, 2022

Related U.S. Application Data
(60) Provisional application No. 63/167,853, filed on Mar. 30, 2021.

(51) Int. Cl. G06Q 40/06

(52) U.S. Cl. CPC G06Q 40/06

(57) ABSTRACT

A method for performing attribution analysis with respect to an investment portfolio is provided. The method includes: identifying a set of attributes, such as asset class, time period, risk profile, liquidity profile, and/or geographic region, of the investment portfolio; generating a graph that indicates respective relationships among attribute-related decision points that impact the investment portfolio; and calculating, based on the respective relationships among decision points, a respective attribution result for each individual attribute, in order to obtain a set of attribution results that is associated with the investment portfolio. The calculations of the attribution results are independently performable and may be performed in parallel.

### CROSS-REFERENCE TO RELATED APPLICATIONS

This application claims priority from U.S. Provisional Patent Application No. 63/167,853, filed in the U.S. Patent and Trademark Office on Mar. 30, 2021, which is hereby incorporated by reference in its entirety.

### BACKGROUND

### 1. Field of the Disclosure

This technology generally relates to methods and systems for performing attribution analysis with respect to investment portfolios across a wide spectrum of asset classes and dimensional aspects.

### 2. Background Information

With respect to an investment portfolio, a portfolio manager (PM) decomposes complex and comprehensive portfolio contributions to analyze different return types, report types, rebalance schedules, and estimations to analyze performance attribution. Large wealth management firms typically have multiple investment engines, with each group of PMs having a slightly different asset class scheme. This results in inefficiencies of having to create and maintain separate attribution calculators for each investment engine, while also requiring the flexibility to handle large numbers of strategies.

A common conventional methodology for attribution calculators is a matrix-based approach with a predefined asset class scheme, requiring calculation paths to be defined and calculated in advance. Each attribution calculator is customized to a corresponding investment engine, and cannot be reused across teams of PMs. In addition to the scalability limitation, the matrix-based approach is inefficient with respect to computation, because the matrix path is fixed and must be calculated sequentially. Performance of the calculation is also typically single-threaded.

PMs also must view and compare performance attribution across multiple dimensions—such as, for example, time period, asset class, risk profile, liquidity profile, geographic region, aggregated or decomposed—in different ways. There is also a need to retain large amounts of data for version auditing (i.e., saving historical results), thus requiring high data maintenance, which downgrades system performance.

Accordingly, there is a need for an improved approach to performing attribution analysis that has the flexibility to handle a variety of investment engines and a variety of dimensional aspects.

### SUMMARY

The present disclosure, through one or more of its various aspects, embodiments, and/or specific features or sub-components, provides, inter alia, various systems, servers, devices, methods, media, programs, and platforms for performing attribution analysis with respect to investment portfolios across a wide spectrum of asset classes and dimensional aspects.

According to an aspect of the present disclosure, a method for performing attribution analysis with respect to an investment portfolio is provided. The method is implemented by at least one processor. The method includes:

identifying, by the at least one processor, a first set of attributes of a first investment portfolio from among a plurality of investment portfolios; generating, by the at least one processor, a graph that indicates respective relationships among a plurality of decision points with respect to the first set of attributes that impact the first investment portfolio; and calculating, by the at least one processor based on the respective relationships among the plurality of decision points, a respective attribution result for each individual attribute from among the first set of attributes, in order to obtain a first set of attribution results that is associated with the first investment portfolio.

The calculating of the respective attribution result may include calculating, for each individual attribute, a respective allocation attribution result and a respective selection attribution result.

The calculating of the respective attribution result for each individual attribute may be independently performable with respect to the calculating of the respective attribution results for other attributes.

The method may further include displaying, on a user interface, the first set of attribution results.

The method may further include: obtaining, for each investment portfolio included in the plurality of investment portfolios, a respective set of attribution results that is associated with the corresponding investment portfolio; and combining the obtained sets of attribution results in order to determine an aggregate set of attribution results that is associated with the plurality of investment portfolios.

The method may further include displaying, on a user interface, the aggregate set of attribution results.

The combining may include: identifying a first path-dependent order and at least a second path-dependent order for combining the obtained sets of attribution results; and performing a first calculation based on the first path-dependent order and at least a second calculation based on each of the at least second path-dependent order. The aggregate set of attribution results may include a first aggregate set of attribution results based on the first calculation and at least a second aggregate set of results based on the at least second calculation.

The method may further include displaying, on a user interface, each of the first aggregate set of attribution results and the at least second aggregate set of results.

The first set of attributes may include at least one from among an asset class, a predetermined time period, a risk profile, a liquidity profile, and a geographic region.

According to another aspect of the present disclosure, a computing apparatus for performing attribution analysis with respect to an investment portfolio is provided. The computing apparatus includes a processor; a memory; a display; and a communication interface coupled to each of the processor, the memory, and the display. The processor is configured to: identify a first set of attributes of a first investment portfolio from among a plurality of investment portfolios; generate a graph that indicates respective relationships among a plurality of decision points with respect to the first set of attributes that impact the first investment portfolio; and calculate, based on the respective relationships among the plurality of decision points, a respective attribution result for each individual attribute from among the first set of attributes, in order to obtain a first set of attribution results that is associated with the first investment portfolio.

The processor may be further configured to calculate, for each individual attribute, a respective allocation attribution result and a respective selection attribution result.

The calculation of the respective attribution result for each individual attribute may be independently performable with respect to the calculations of the respective attribution results for other attributes.

The processor may be further configured to cause the display to display, on a user interface of the display, the first set of attribution results.

The processor may be further configured to: obtain, for each investment portfolio included in the plurality of investment portfolios, a respective set of attribution results that is associated with the corresponding investment portfolio; and combine the obtained sets of attribution results in order to determine an aggregate set of attribution results that is associated with the plurality of investment portfolios.

The processor may be further configured to cause the display to display, on a user interface of the display, the aggregate set of attribution results.

The processor may be further configured to perform the combining by: identifying a first path-dependent order and at least a second path-dependent order for combining the obtained sets of attribution results; and performing a first calculation based on the first path-dependent order and at least a second calculation based on each of the at least second path-dependent order. The aggregate set of attribution results may include a first aggregate set of attribution results based on the first calculation and at least a second aggregate set of results based on the at least second calculation.

The processor may be further configured to cause the display to display, on a user interface of the display, each of the first aggregate set of attribution results and the at least second aggregate set of results.

The first set of attributes may include at least one from among an asset class, a predetermined time period, a risk profile, a liquidity profile, and a geographic region.

According to yet another aspect of the present disclosure, a non-transitory computer readable storage medium storing instructions for performing attribution analysis with respect to an investment portfolio is provided. The storage medium includes executable code which, when executed by a processor, causes the processor to: identify a first set of attributes of a first investment portfolio from among a plurality of investment portfolios; generate a graph that indicates respective relationships among a plurality of decision points with respect to the first set of attributes that impact the first investment portfolio; and calculate, based on the respective relationships among the plurality of decision points, a respective attribution result for each individual attribute from among the first set of attributes, in order to obtain a first set of attribution results that is associated with the first investment portfolio.

When executed by the processor, the executable code may be further configured to cause the processor to calculate, for each individual attribute, a respective allocation attribution result and a respective selection attribution result.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for performing attribution analysis with respect to investment portfolios across a wide spectrum of asset classes and dimensional aspects.

FIG. 4 is a flowchart of a process for implementing a method for performing attribution analysis with respect to investment portfolios across a wide spectrum of asset classes and dimensional aspects, according to an exemplary embodiment.

FIG. 5 is an illustration of a set of attributes of an investment vehicle, as implemented in a method for performing attribution analysis with respect to investment portfolios across a wide spectrum of asset classes and dimensional aspects, according to an exemplary embodiment.

FIG. 6 is an illustration of how the attributes of FIG. 5 are connectable for representing a decision making process, as implemented in a method for performing attribution analysis with respect to investment portfolios across a wide spectrum of asset classes and dimensional aspects, according to an exemplary embodiment.

FIG. 7 is an illustration of a computation of an allocation of an individual attribute in a method for performing attribution analysis with respect to investment portfolios across a wide spectrum of asset classes and dimensional aspects, according to an exemplary embodiment.

FIG. 8 is an illustration of a computation of aggregated performance attribution results across multiple portfolios as implemented in a method for performing attribution analysis with respect to investment portfolios across a wide spectrum of asset classes and dimensional aspects, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

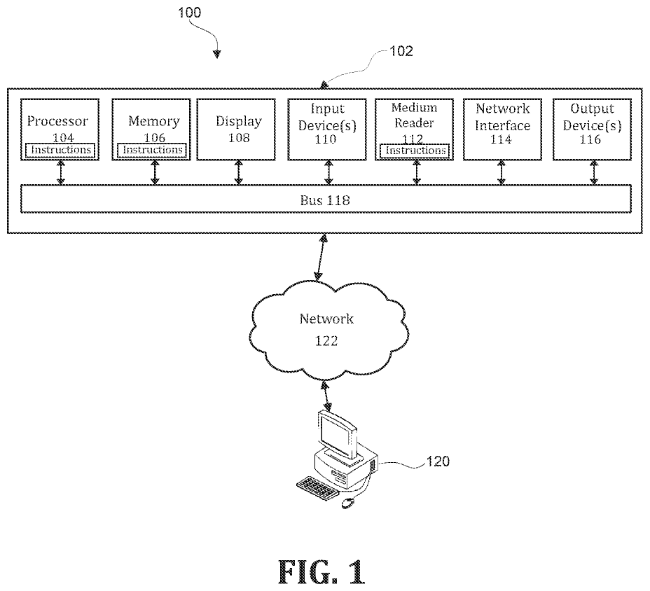

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for performing attribution analysis with respect to investment portfolios across a wide spectrum of asset classes and dimensional aspects.

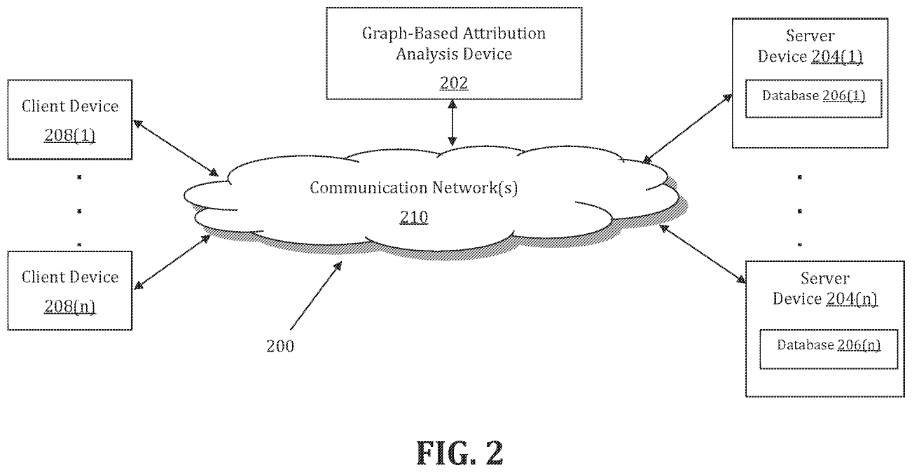

Referring to FIG. 2, a schematic of an exemplary network environment 200 for implementing a method for performing attribution analysis with respect to investment portfolios across a wide spectrum of asset classes and dimensional aspects is illustrated. In an exemplary embodiment, the method is executable on any networked computer platform, such as, for example, a personal computer (PC).

The method for performing attribution analysis with respect to investment portfolios across a wide spectrum of asset classes and dimensional aspects may be implemented by a Graph-Based Attribution Analysis (GBAA) device 202. The GBAA device 202 may be the same or similar to the computer system 102 as described with respect to FIG. 1. The GBAA device 202 may store one or more applications that can include executable instructions that, when executed by the GBAA device 202, cause the GBAA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GBAA device 202 itself, may be located in virtual server(s) running in a cloud-based computing environment rather than being tied to one or more specific physical network computing devices. Also, the application(s) may be running in one or more virtual machines (VMs) executing on the GBAA device 202. Additionally, in one or more embodiments of this technology, virtual machine(s) running on the GBAA device 202 may be managed or supervised by a hypervisor.

In the network environment 200 of FIG. 2, the GBAA device 202 is coupled to a plurality of server devices 204(1)-204(n) that hosts a plurality of databases 206(1)-206(n), and also to a plurality of client devices 208(1)-208(n) via communication network(s) 210. A communication interface of the GBAA device 202, such as the network interface 114 of the computer system 102 of FIG. 1, operatively couples and communicates between the GBAA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GBAA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and GBAA devices that efficiently implement a method for performing attribution analysis with respect to investment portfolios across a wide spectrum of asset classes and dimensional aspects.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The GBAA device 202 may be a standalone device or integrated with one or more other devices or apparatuses, such as one or more of the server devices 204(1)-204(n), for example. In one particular example, the GBAA device 202 may include or be hosted by one of the server devices 204(1)-204(n), and other arrangements are also possible. Moreover, one or more of the devices of the GBAA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the GBAA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to historical attribution analysis results and individual investment portfolios.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the GBAA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the GBAA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the GBAA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the GBAA device 202, the server devices 204(1)-204(n), or the client devices 208(1)-208(n), for example, may be configured to operate as virtual instances on the same physical machine. In other words, one or more of the GBAA device 202, the server devices 204(1)-204(n), or the client devices 208(1)-208(n) may operate on the same physical device rather than as separate devices communicating through communication network(s) 210. Additionally, there may be more or fewer GBAA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

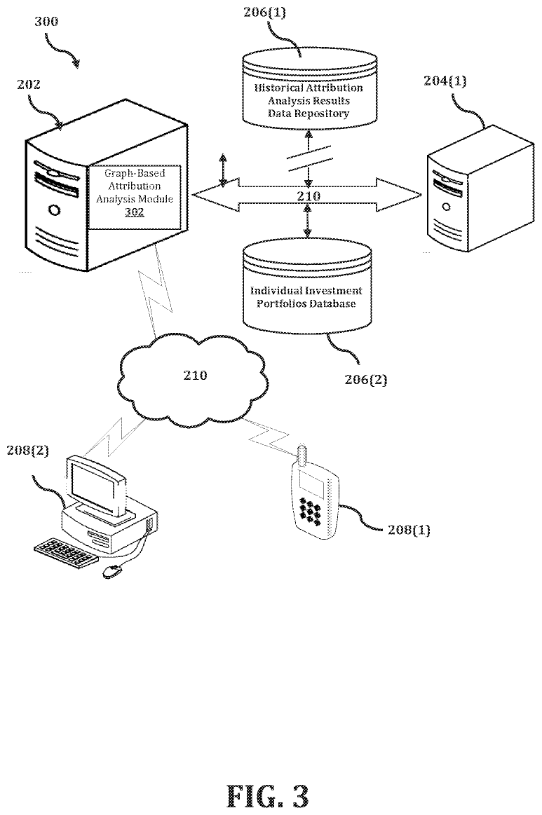

The GBAA device 202 is described and illustrated in FIG. 3 as including a graph-based attribution analysis module 302, although it may include other rules, policies, modules, databases, or applications, for example. As will be described below, the graph-based attribution analysis module 302 is configured to implement a method for performing attribution analysis with respect to investment portfolios across a wide spectrum of asset classes and dimensional aspects.

An exemplary process 300 for implementing a mechanism for performing attribution analysis with respect to investment portfolios across a wide spectrum of asset classes and dimensional aspects by utilizing the network environment of FIG. 2 is illustrated as being executed in FIG. 3. Specifically, a first client device 208(1) and a second client device 208(2) are illustrated as being in communication with GBAA device 202. In this regard, the first client device 208(1) and the second client device 208(2) may be “clients” of the GBAA device 202 and are described herein as such. Nevertheless, it is to be known and understood that the first client device 208(1) and/or the second client device 208(2) need not necessarily be “clients” of the GBAA device 202, or any entity described in association therewith herein. Any additional or alternative relationship may exist between either or both of the first client device 208(1) and the second client device 208(2) and the GBAA device 202, or no relationship may exist.

Further, GBAA device 202 is illustrated as being able to access a historical attribution analysis results data repository 206(1) and an individual investment portfolios database 206(2). The graph-based attribution analysis module 302 may be configured to access these databases for implementing a method for performing attribution analysis with respect to investment portfolios across a wide spectrum of asset classes and dimensional aspects.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the GBAA device 202 via broadband or cellular communication. Of course, these embodiments are merely exemplary and are not limiting or exhaustive.

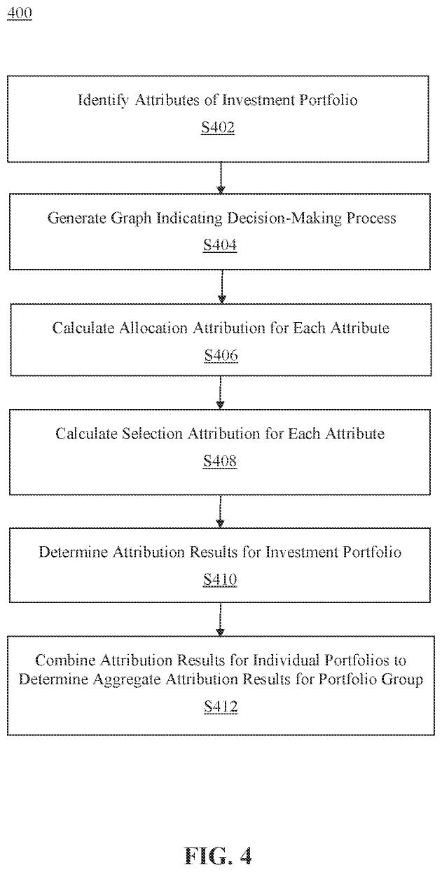

Upon being started, the graph-based attribution analysis module 302 executes a process for performing attribution analysis with respect to investment portfolios across a wide spectrum of asset classes and dimensional aspects. An exemplary process for performing attribution analysis with respect to investment portfolios across a wide spectrum of asset classes and dimensional aspects is generally indicated at flowchart 400 in FIG. 4.

In process 400 of FIG. 4, at step S402, the graph-based attribution analysis module 302 identifies a set of attributes of an investment portfolio. In an exemplary embodiment, the set of attributes may include any one or more of an asset class, a predetermined time period, a risk profile, a liquidity profile, a geographic region, and/or an industry sector.

At step S404, the graph-based attribution analysis module 302 generates a graph that indicates respective relationships among the plurality of decision points that impact the investment portfolio. In this aspect, the graph may show which attributes are considered in making a decision about the investment portfolio. In an exemplary embodiment, the graph may also show which decisions are made first and which are made subsequently, i.e., an ordered sequence of decisions.

At step S406, the graph-based attribution analysis module 302 calculates, for each attribute, an allocation attribution result that relates to a weight of an impact of the particular attribute as compared with a sum of the impacts of the attributes that act as sub-decision nodes on the graph. Then, at step S408, the graph-based attribution analysis module 302 calculates, for each attribute, a selection attribution result that relates to a comparison of the returns for the sub-decision nodes with the return for the particular attribute. As a result of the calculations of the allocation attribution results and the selection attribution results, a full set of attribution results that is associated with the investment portfolio may be determined at step S410.

In an exemplary embodiment, the calculations of the allocation attribution results and the selection attribution results for any particular attribute may be performed independently with respect to the calculations of the corresponding attribution results for other attributes. Therefore, the calculations of attribution results for all attributes may be performed in parallel.

At step S412, the graph-based attribution analysis module 302 combines the attribution results that are associated with each individual investment portfolio from among a group of portfolios, in order to determine aggregate attribution results for the group.

Portfolio contribution is portfolio total return (PTR) over benchmark total return (BTR). Portfolio attribution is determined by decomposition thereof into three contributing parts: allocation attribution; selection attribution; and interaction attribution.

Referring to Table 1, an example portfolio and benchmark is provided. Portfolio Equity Weight=PEW; Portfolio Cash Weight=PCW; Portfolio Total Weight=PTW; Benchmark Equity Weight=BEW; Benchmark Cash Weight=BCW; Benchmark Total Weight=BTW; Portfolio Equity Return=PER; Portfolio Cash Return=PCR; Portfolio Total Return=PTR; Benchmark Equity Return=BER; Benchmark Cash Return=BCR; Benchmark Total Return=BTR.

TABLE 1

| | Portfolio | Benchmark | Portfolio | Benchmark |
|---|---|---|---|---|
| Sector | Weight | Weight | Return | Return |
| Equity | PEW = 90% | BEW = 70% | PER = 5.00% | BER = 3.00% |
| Cash | PCW = 10% | BCW = 30% | PCR = 1.00% | BCR = 1.00% |
| Total | PTW = | BTW = | PTR = | BTR = |
| | PEW + | BEW + | PEW*PER + | BEW*BER + |
| | PCW = | BCW = | PCW*PCR = | BCW*BCR = |
| | 100% | 100% | 4.60% | 2.40% |

### Portfolio Total Attribution=PTR−BTR=4.60%−2.40%=2.20%

Referring to Table 2, an example of a portfolio attribution that is determined in accordance with the classic Brinson-Fachler attribution model is provided:

TABLE 2

| | Allocation | Selection | Interaction | |
|---|---|---|---|---|
| Sector | Attribution | Attribution | Attribution | Total |
| Equity | (PEW- | BEW*(PER- | (PEW- | 0.12% + |
| | BEW)*(BER- | BER) = | BEW)*(PER- | 1.40% + |
| | BTR) = | 1.40% | BER) = | 0.40 = 1.92% |
| | 20%*0.6% = | | 0.40% | |
| | 0.12% | | | |
| Cash | (PCW- | BCW)*(PCR- | (PCW- | 0.28% + |
| | BCW*(BCR- | BCR) = | BCW*(PCR- | 0.00% + |
| | BTR) = | 0.00% | BCR) = | 0.00% = |
| | (−20%)*(−1.4%) = | | 0.00% | 0.28% |
| | 0.28% | | | |
| Total | 0.12% + | 1.40% + | 0.40% + | 0.40% + |
| | 0.28% = | 0.00% = | 0.00% = | 1.40% + |
| | 0.40% | 1.40% | 0.40% | 0.40% = |
| | | | | 1.92% + |
| | | | | 0.28% = |
| | | | | 2.20% |

### Total Allocation Attribution+Total Selection Attribution+Total Interaction Attribution=0.40%+1.40%+0.40%=2.20%=Total Attribution.

Part 1: Allocation Attribution=(PEW−BEW)*(BER−BTR)+(PCW−BCW)*(BCR-BTR). In general, a portfolio should overweight on outperforming assets relative to the benchmark, i.e., allocate more on good assets.

Part 2: Selection Attribution=BEW*(PER-BER)+BCW*(PCR−BCR). In general, a portfolio should select a better performance instrument over the same benchmark asset class with the same weight, i.e., pick good stocks.

Part 3: Interaction Attribution=(PEW−BEW)*(PER-BER)+(PCW−BCW)*(PCR−BCR). Many implementations will combine interaction with selection, thereby yielding the following combined expression: Selection Attribution+Interaction Attribution=PEW*(PER-BER)+PCW*(PCR−BCR).

Part 1=(PEW−BEW)*(BER−BTR)+(PCW−BCW)*(BCR−BTR)=(PEW−BEW)*BER−(PEW−BEW)*BTR+(PCW−BCW)*BCR−(PCW−BCW)*BTR=(PEW−BEW)*BER+(PCW−BCW)*BCR−(PEW−BEW+PCW−BCW)*BTR=(PEW−BEW)*BER+(PCW−BCW)*BCR−(1−1)*BTR=(PEW−BEW)*BER+(PCW−BCW)*BCR=PEW*BER+PCW*BCR−BEW*BER−BCW*BCR=PEW*BER+PCW*BCR−BTR

Part 2+Part 3=BEW*(PER−BER)+BCW*(PCR−BCR)+(PEW−BEW)*(PER−BER)+(PCW−BCW)*(PCR−BCR)=PEW*(PER−BER)+PCW*(PCR−BCR)=PEW*PER+PCW*PCR−PEW*BER−PCW*BCR=PTR−PEW*BER−PCW*BCR

Accordingly: Portfolio Total Attribution=Part 1+Part 2+Part 3=PEW*BER+PCW*BCR−BTR+PTR−PEW*BER−PCW*BCR=PTR−BTR=Portfolio Total Contribution. Portfolio Total Contribution can be decomposed to three component parts of Portfolio Attribution, i.e., allocation, selection and interaction.

Aggregating portfolio return over same period across multiple asset classes is performable by using arithmetic. Aggregating portfolio return on the same asset over multiple periods is geometric.

Aggregating portfolio total return across multiple assets and over multiple periods is path dependent. In this aspect, adding all the assets returns in the same period, then compounding over time yields a different result than first compounding each asset return over multiple periods, then add all the asset compound returns.

In an exemplary embodiment, a graph-node attribution analysis approach to attribution calculation uses a tree structure such that each level of the asset classification scheme is represented as a node/branch which can be abstracted out and calculated individually as its own parent/child node. This approach allows for specific characteristics or constraints to be placed on specific parent/child nodes in order to better reflect business relationships and an investment decision-making process for scalable and faster performance attribution analysis. The approach disclosed herein isolates parallel calculations so multiple attribution models can be run at once, each with different variables. Since the constraints are only applied to one node, recoding and/or recalculating other nodes of the graph (i.e., tree) are not needed. By contrast, in the conventional matrix-based approach, one change in the constraint/attribute of any level of the hierarchy results in recalculating the entire path again.

Advantages: In an exemplary embodiment, the graph-node attribution analysis approach provides flexibility to change specific nodes in the graph tree which allows supporting different asset and region classification schemes required by different investment engines. This is a major advantage for large financial institutions and firms that have different investment engines within the same organization to leverage a common technology platform, while allowing for independent portfolio management. Further, portfolio managers (PMs) can change the asset class scheme or specific constraints to modify the model without incurring a heavy cost of recoding a static attribution model, as used with the conventional matrix-based approach.

Additionally, in an exemplary embodiment, the graph-node attribution analysis approach allows each parent/child calculation to be computed separately, thereby enabling the attribution analysis to scale horizontally across a distributed computing platform (e.g., cloud) with parallel computation, thus yielding faster performance by a factor of approximately 20. As a result, a frequency of running attribution analysis reports may be significantly increased, e.g., from monthly to weekly, and even daily.

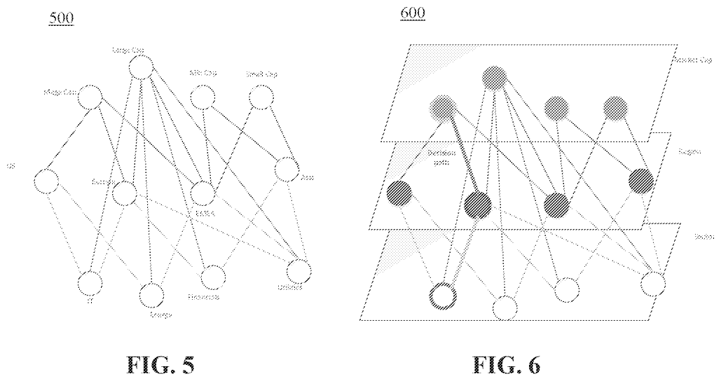

FIG. 5 is an illustration 500 of a set of attributes of an investment vehicle, as implemented in a method for performing attribution analysis with respect to investment portfolios across a wide spectrum of asset classes and dimensional aspects, according to an exemplary embodiment. FIG. 6 is an illustration 600 of how the attributes of FIG. 5 are connectable for representing a decision making process, as implemented in a method for performing attribution analysis with respect to investment portfolios across a wide spectrum of asset classes and dimensional aspects, according to an exemplary embodiment.

Referring to FIG. 5 and FIG. 6, in view of the fact that each investment vehicle has many attributes, e.g., asset class=Large Cap fund, geographic region=United States (US), and industry sector=Information Technology (IT), a connection among these attributes to represent investor's decision making process. For example, a portfolio manager may decide to invest in Large Cap funds, then prefer US region, and also prefer to put more money in IT, and less money in energy. This decision-making process can be represented as a decision path, as illustrated in the graph shown in FIG. 6. Attribution can then be modeled as the way to compute along all the decision paths to evaluate the impact of an investor's decisions, e.g., whether generating profit or loss.

Using a graph to represent an attribution process provides the abstraction of the attribution problem to a computer science graph traversal problem, which helps to build an attribution engine with a core algorithm stable for different kinds of attribution methodologies. The abstraction can separate the data collection process from the engine computation process.

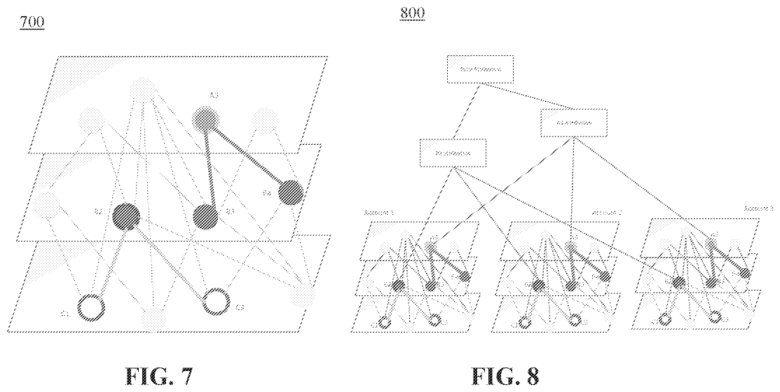

FIG. 7 is an illustration 700 of a computation of an allocation of an individual attribute in a method for performing attribution analysis with respect to investment portfolios across a wide spectrum of asset classes and dimensional aspects, according to an exemplary embodiment. FIG. 8 is an illustration 800 of a computation of aggregated performance attribution results across multiple portfolios as implemented in a method for performing attribution analysis with respect to investment portfolios across a wide spectrum of asset classes and dimensional aspects, according to an exemplary embodiment.

Referring to FIG. 7 and FIG. 8, the abstraction of performance attribution to graph traversal also enables parallel computing in obtaining attribution results. As shown in FIG. 7, in the decision path, each node (e.g., node A3 and node B2) can independently compute an allocation call, i.e., an overweight/underweight impact compared to the sum of its sub-decision points, and a selection call, i.e., returns of sub-decision points compared to this point. The independency of the node computation allows for a computation of each node's result in parallel.

In addition, the parallel computing can be applied for handling multiple portfolios at the same time, as shown in FIG. 8. In a situation of processing multiple portfolios to general aggregated performance attribution results, e.g., handling composite attribution, every account's attribution may be computed in parallel, and then the attribution results of the individual accounts may be aggregated to determine the total attribution.

In an exemplary embodiment, the parallel computing may be achieved by using any parallel computation technologies, for example, using multi-threading, multi-processing, a graphics processing unit (GPU), or on cloud with multiple virtual machines, and using different frameworks, for example, Spark with map-reduce, or Tensorflow on GPUs. Mixing of different technologies may also be implemented, e.g., using multi-threading of computing multiple nodes in parallel in one graph, and using Spark map-reduce to handle multiple graphs in parallel, and aggregating results at the end.

In an exemplary embodiment, either or both of the illustration 700 and the illustration 800 may be displayed on a user interface in order to assist a user with visualizing the allocations of an individual attribute and/or aggregated performance attribution results across multiple portfolios as implemented in a method for performing attribution analysis with respect to investment portfolios across a wide spectrum of asset classes and dimensional aspects.

Accordingly, with this technology, an optimized process for performing attribution analysis with respect to investment portfolios across a wide spectrum of asset classes and dimensional aspects is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing attribution analysis with respect to an investment portfolio, the method being implemented by at least one processor, the method comprising:
identifying, by the at least one processor, a first set of attributes of a first investment portfolio from among a plurality of investment portfolios;
generating, by the at least one processor, a graph that indicates respective relationships among a plurality of decision points with respect to the first set of attributes that impact the first investment portfolio; and
calculating, by the at least one processor based on the respective relationships among the plurality of decision points, a respective attribution result for each individual attribute from among the first set of attributes, in order to obtain a first set of attribution results that is associated with the first investment portfolio.

2. The method of claim 1, wherein the calculating of the respective attribution result comprises calculating, for each individual attribute, a respective allocation attribution result and a respective selection attribution result.

3. The method of claim 1, wherein the calculating of the respective attribution result for each individual attribute is independently performable with respect to the calculating of the respective attribution results for other attributes.

4. The method of claim 1, further comprising displaying, on a user interface, the first set of attribution results.

5. The method of claim 1, further comprising:
obtaining, for each investment portfolio included in the plurality of investment portfolios, a respective set of attribution results that is associated with the corresponding investment portfolio; and
combining the obtained sets of attribution results in order to determine an aggregate set of attribution results that is associated with the plurality of investment portfolios.

6. The method of claim 5, further comprising displaying, on a user interface, the aggregate set of attribution results.

7. The method of claim 5, wherein the combining comprises:
identifying a first path-dependent order and at least a second path-dependent order for combining the obtained sets of attribution results; and
performing a first calculation based on the first path-dependent order and at least a second calculation based on each of the at least second path-dependent order,
wherein the aggregate set of attribution results includes a first aggregate set of attribution results based on the first calculation and at least a second aggregate set of results based on the at least second calculation.

8. The method of claim 7, further comprising displaying, on a user interface, each of the first aggregate set of attribution results and the at least second aggregate set of results.

9. The method of claim 1, wherein the first set of attributes includes at least one from among an asset class, a predetermined time period, a risk profile, a liquidity profile, and a geographic region.

10. A computing apparatus for performing attribution analysis with respect to an investment portfolio, the computing apparatus comprising:
a processor;
a memory;
a display; and
a communication interface coupled to each of the processor, the memory, and the display,
wherein the processor is configured to:
identify a first set of attributes of a first investment portfolio from among a plurality of investment portfolios;
generate a graph that indicates respective relationships among a plurality of decision points with respect to the first set of attributes that impact the first investment portfolio; and
calculate, based on the respective relationships among the plurality of decision points, a respective attribution result for each individual attribute from among the first set of attributes, in order to obtain a first set of attribution results that is associated with the first investment portfolio.

11. The computing apparatus of claim 10, wherein the processor is further configured to calculate, for each individual attribute, a respective allocation attribution result and a respective selection attribution result.

12. The computing apparatus of claim 10, wherein the calculation of the respective attribution result for each individual attribute is independently performable with respect to the calculations of the respective attribution results for other attributes.

13. The computing apparatus of claim 10, wherein the processor is further configured to cause the display to display, on a user interface of the display, the first set of attribution results.

14. The computing apparatus of claim 10, wherein the processor is further configured to:
obtain, for each investment portfolio included in the plurality of investment portfolios, a respective set of attribution results that is associated with the corresponding investment portfolio; and
combine the obtained sets of attribution results in order to determine an aggregate set of attribution results that is associated with the plurality of investment portfolios.

15. The computing apparatus of claim 14, wherein the processor is further configured to cause the display to display, on a user interface of the display, the aggregate set of attribution results.

16. The computing apparatus of claim 14, wherein the processor is further configured to perform the combining by:
identifying a first path-dependent order and at least a second path-dependent order for combining the obtained sets of attribution results; and
performing a first calculation based on the first path-dependent order and at least a second calculation based on each of the at least second path-dependent order,
wherein the aggregate set of attribution results includes a first aggregate set of attribution results based on the first calculation and at least a second aggregate set of results based on the at least second calculation.

17. The computing apparatus of claim 16, wherein the processor is further configured to cause the display to display, on a user interface of the display, each of the first aggregate set of attribution results and the at least second aggregate set of results.

18. The computing apparatus of claim 10, wherein the first set of attributes includes at least one from among an asset class, a predetermined time period, a risk profile, a liquidity profile, and a geographic region.

19. A non-transitory computer readable storage medium storing instructions for performing attribution analysis with respect to an investment portfolio, the storage medium comprising executable code which, when executed by a processor, causes the processor to:
identify a first set of attributes of a first investment portfolio from among a plurality of investment portfolios;
generate a graph that indicates respective relationships among a plurality of decision points with respect to the first set of attributes that impact the first investment portfolio; and
calculate, based on the respective relationships among the plurality of decision points, a respective attribution result for each individual attribute from among the first set of attributes, in order to obtain a first set of attribution results that is associated with the first investment portfolio.

20. The storage medium of claim 19, wherein when executed by the processor, the executable code is further configured to cause the processor to calculate, for each individual attribute, a respective allocation attribution result and a respective selection attribution result.
